(19) United States
(12) Patent Application Publication
(10) Pub. No.: US 2004/0010459 A1
(43) Pub. Date: Jan. 15, 2004

(54) Interactive methods and systems for calculating return on investment for employee services programs

(75) Inventor: David Zatlukal, Sandy Hook, CT (US)

Correspondence Address: LAW OFFICE OF BARRY R LIPSITZ, 755 MAIN STREET, MONROE, CT, 06468, US

(73) Assignee: LifeCare, Inc., Westport, CT

(21) Appl. No.: 10/447,488

(22) Filed: May 28, 2003

Related U.S. Application Data
(60) Provisional application No. 60/395,092, filed on Jul. 10, 2002.

(51) Int. Cl. G06F 17/60

(52) U.S. Cl. 705/36

(57) ABSTRACT

The present invention provides interactive methods and systems for calculating return on investment for employee services programs. Industry specific data for an employer is provided. Employer statistics are obtained. At least one data set regarding utilization of an employee services program is also provided. The percentage utilization of the employee service program is estimated based on the data set. The return on investment for the employee service program may be calculated based on the industry specific data, the employer statistics, and the estimated utilization. At least one of the employer specific data, the employer statistics, and the estimated use can be interactively varied to determine the resultant change on the return on investment calculation.

This application claims the benefit of U.S. provisional patent application No. 60/395,092 filed on Jul. 10, 2002, which is incorporated herein and made a part hereof by reference.

### BACKGROUND OF THE INVENTION

The present invention relates to interactive methods and systems for calculating return on investment (ROI) for an employee services program. In particular, the present invention uses a unique combination of data sources to provide accurate ROI data regarding the services provided, including industry data, employer data, and proprietary data obtained from employees who have previously used the service program at issue.

Prior art methods and systems for calculating ROI are based only on employee information and industry statistics.

It would be advantageous to obtain feedback regarding the services provided and use such information to more accurately calculate the ROI for the service program. It would be further advantageous to allow for interactively varying at least some of the inputs for the ROI calculation to determine the resultant change in the ROI.

Such an ROI calculator may be advantageously used by the provider of the services as a marketing tool. For example, the provider can use the ROI calculator to accurately show an employer the range of return on investment they could achieve based on varying degrees of utilization of the service program. Further, the employer's Human Resources Department can use the ROI calculator of the present invention to prove to the employer that the service program is actually saving the company money, as well as providing benefits to employees and increasing employee moral.

The methods and apparatus of the present invention provide the foregoing and other advantages.

### SUMMARY OF THE INVENTION

The present invention utilizes a unique combination of data in calculating the ROI. The three types of data used are; (1) industry data obtained from government sources, publicly available human resource statistics, and the like, which data includes absenteeism rates for the industry at issue, reasons for absenteeism, employee turnover rate by industry, reasons for employee turnover; (2) employer information, such as number of employees, average salary, number of management employees, number of clerical employees, number of other employees by group (e.g., engineers, administrative, production workers, and the like), average cost of benefits, work days per year, hours per work day, and the like; and (3) proprietary information obtained from actual employees and others who have used the employee services program regarding the effectiveness of the program, including increased productivity achieved by using the service, decreased absenteeism achieved by using the service, and reduced turnover achieved by using the service. Such information may be obtained via a confidential survey.

The present invention provides an interactive ROI calculator, which may be provided in the form of a spreadsheet. A user, such as an employer, can interactively manipulate the data to determine the net change in the ROI. For example, industry data can be changed to determine its effect on the ROI. Similarly, the employer's data (such as number of employees, average pay per employee, benefits costs per employee, etc.) can be changed to determine the effect on the ROI.

Although the ROI methods and systems of the present invention are particularly applicable to employee services programs, such as referral services, benefits services, information services, counseling services, and other services provided to employees by a third party, such as LifeCare, Inc. (the assignee of the present invention) or an Employee Assistance Program provider (EAP), it should be appreciated that the present invention can be applied to a wide variety of service industries.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows a flowchart of an example implementation of the invention;

FIG. 3 shows example inputs for use with an example embodiment of the invention;

FIG. 4 shows an example calculation of ROI based on cost savings due to reduced absenteeism in accordance with the invention;

FIG. 5 shows an example calculation of ROI based on cost savings due to employee retention in accordance with the invention;

FIG. 6 shows an example calculation of ROI based on cost savings due to improved productivity in accordance with the invention; and

FIG. 7 shows an example calculation of ROI based on the combined calculations shown in FIGS. 4-6.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

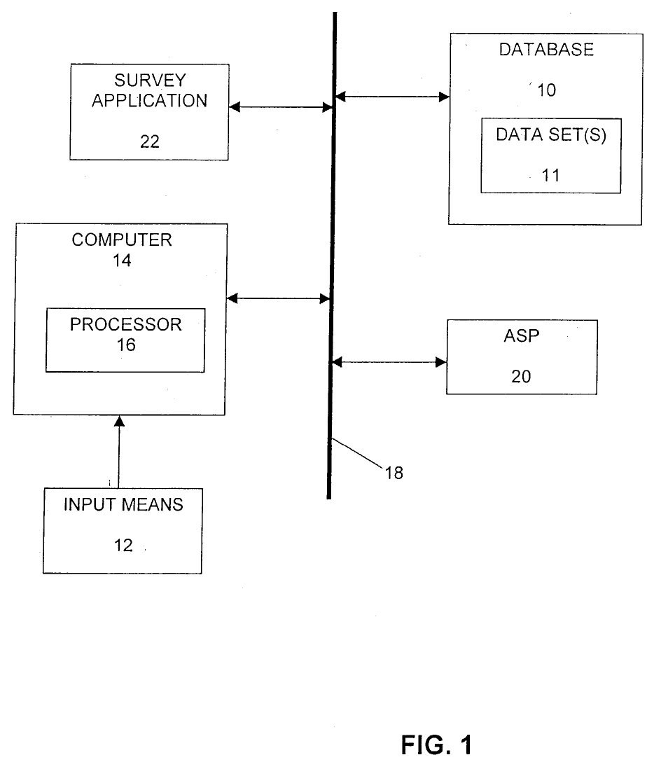

The present invention provides interactive methods and apparatus for calculating return on investment for employee services programs. A block diagram of an example embodiment of the invention is shown in FIG. 1. Industry specific data for an employer is provided as an input to a processor 16 (which may be part of a computer 14). Employer statistics are obtained and provided as an input to the processor 16. A database 10 for storing at least one data set 11 regarding utilization of an employee services program is also provided. The percentage utilization of the employee service program is estimated based on the data set 11. Input means 12 may be provided for inputting the industry specific data, the employer statistics, and the estimated percentage utilization. The processor 16 calculates the return on investment for the employee service program based on the industry specific data, the employer statistics, and the estimated utilization. At least one of the employer specific data, the employer statistics, and the estimated use can be interactively varied (via input means 12) to determine the resultant change on the return on investment calculation.

The input means 12 may be a computer keyboard, a drop down menu controlled by a mouse or touch pad, or the like. The industry specific data, employer statistics, and the estimated percentage utilization may be input into a computer program (e.g., run by the processor 16), such as a spreadsheet program, for completing the ROI calculation.

The spreadsheet program may be accessible via a network 18, such as a global communication network, the Internet, a wide area network, a local area network, an intranet, or the like. The ROI spreadsheet may alternatively be sold as a software package or downloaded over a network 18 from an application service provider (ASP) 20. The database 10 may also be accessible over the network 18 by the computer 14.

The industry specific data may comprise at least one of average employee salaries, daily unscheduled absenteeism rates, replacement costs as a percentage of salary, voluntary employee turnover, work days per year, and the like.

The employer statistics may comprise at least one of number of employees, cost of benefits, employee salaries. The number of employees may be subdivided into different categories of employees (e.g., administrative, management, engineering, clerical, maintenance, and other such categories of employees). Different data sets may be provided for different categories of employees. The return on investment calculations may be performed for all employees of the company as a whole, or separately for selected employee categories within the company.

At least one data set 11 may comprise personalized data obtained from employees who have previously used the employee service program. The at least one data set 11 may be obtained by surveying the employees who have previously used the employee service program. The survey may be an online survey, an email survey, an in-person survey, a mail-in survey, a combination of the foregoing, or the like. The survey may be a confidential survey. A survey application 22 may be implemented to provide and distribute online and email surveys to the employees. Further, the survey application 22 may communicate the survey results to the database 10 for formulation of the data sets 11.

Different data sets 11 may be provided for different types of service programs. For example, there may be one data set for a referral program, one data set for a benefits assistance program, one data set for an information service program, and the like. Further, different data sets may be provided for different industries.

Each data set 11 may comprise one of actual number of hours of lost productivity averted through use of the service per employee, actual number of days of absenteeism averted through use of the service per employee, actual number of employees retained through use of the service, and similar information regarding the benefits of the service.

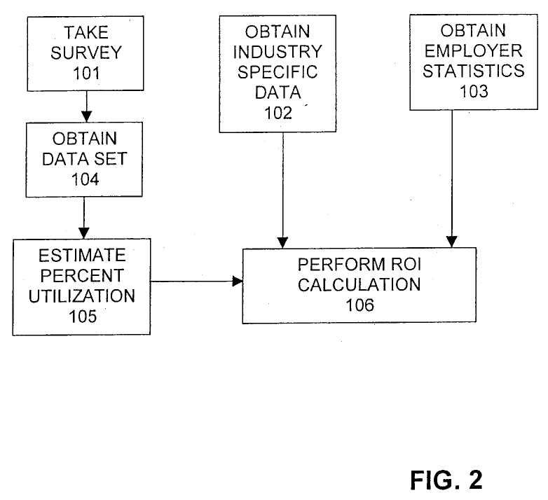

FIG. 2 shows a flowchart of an example embodiment of the present invention. A survey of employees who have used the employee service program is taken (Step 101). The data set regarding utilization of an employee services program is obtained from the survey results (Step 104). The percentage utilization of the employee service program is estimated based on the data set (step 105). In addition, the industry specific data is obtained (102). This industry specific data may be obtained from various sources, such as The U.S. Bureau of Labor Statistics, U.S. Department of Health and Human Services, employment studies, publicly available human resources information, employer surveys, and the like. Employer statistics are obtained from the employer (Step 103). The estimated percent utilization, industry specific data, and employer statistics are then used to calculate the return on investment for the employee service program (Step 106). Those skilled in the art will appreciate that the steps of taking the survey 101, obtaining industry specific data 102, and obtaining employer statistics 103 may occur in any order.

The employee service program may comprise at least one of an employee assistance program, a referral service program, a counseling service program, an employee information program, a benefits service program, or the like. These programs may include information, referrals, and counseling on all issues faced by an employee, such as child care issues, elder care issues, pet care issues, health care issues, education issues, employee benefits issues, financial issues, human resource issues, employee relocation issues, employment issues, retirement, health and wellness issues, and any other types of personal or professional issues of concern to an employee.

The return on investment calculation may comprise at least one of costs saved due to reduced absenteeism, costs saved due to increased productivity, costs saved due to reduced employee turnover, as well as other cost savings obtained through use of the service program at issue.

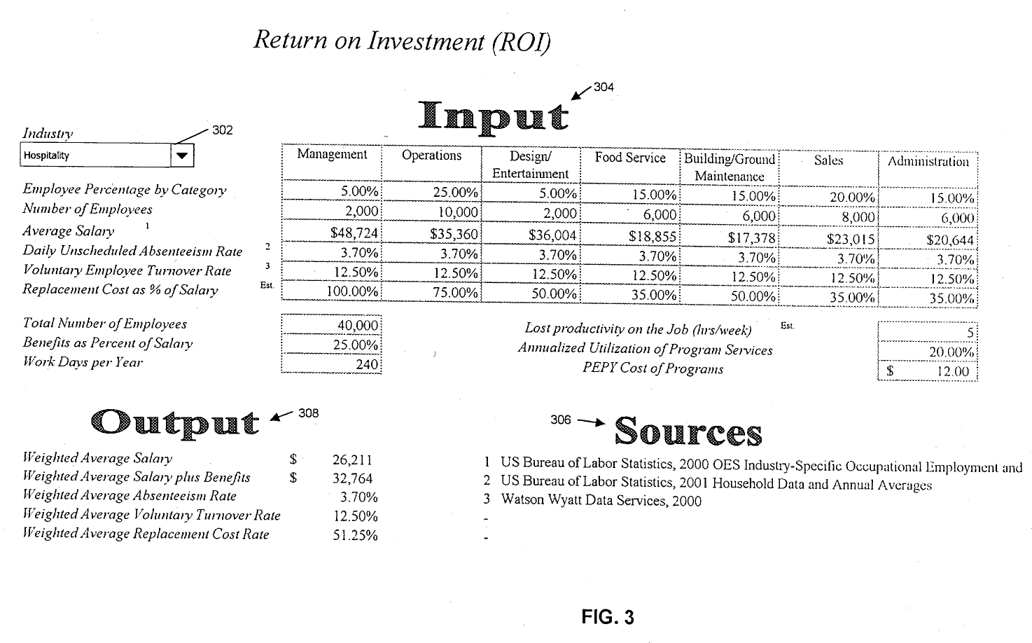

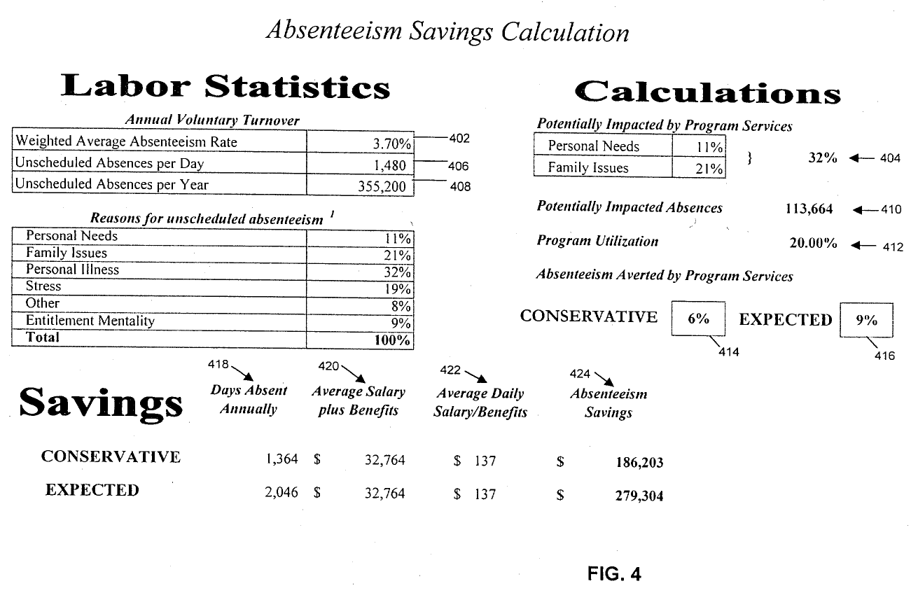

Example implementations of the invention are shown in FIGS. 3-7. FIG. 3 shows an input page 300 which includes a dropdown window for the applicable industry. The input page may be in the form of a spreadsheet. The dropdown window 302 shows “Hospitality” as the industry selected. By changing the industry selected using the dropdown window 302, the inputs 304 will automatically be adjusted to conform to appropriate inputs for the selected industry. As discussed above, the inputs 304 are from a variety of sources, including industry data sources 306, as well as employer information, and proprietary data. The inputs to the various ROI calculations shown on FIGS. 4-6 will automatically be adjusted based on the inputs 304 for a selected industry. The spreadsheet 300 computes outputs 308 for use in the ROI calculations shown in FIGS. 4-6.

FIG. 4 shows an example embodiment of the invention for use in calculating the ROI based on cost savings due to reduced absenteeism. In such an embodiment, the industry statistics may comprise the average unscheduled absenteeism rate 402 for the industry of the employer. The employer specific information may comprise number of employees, average salary per employee, and number of work days per year (see, e.g., inputs 304 of FIG. 3). The data set may comprise a percentage of the unscheduled absences potentially avoided through utilization of the service program 404. The calculation of the return on investment may comprise: (1) multiplying the unscheduled absenteeism rate 402 by the number of employees to provide the number of unscheduled absences per day 406 for the employer; (2) multiplying the number of unscheduled absences per day 406 by the number of work days per year to provide the number of unscheduled absences per year 408; (3) multiplying the number of unscheduled absences per year 408 by the percentage of unscheduled absences potentially avoided by utilization of the service program 404 to provide a number of potentially impacted absences 410; (4) multiplying the number of potentially impacted absences 410 by the estimated percentage utilization 412 to provide an estimated number of absences potentially avoided (not shown); (5) estimating a percentage of absences actually avoided (e.g., conservative estimate 414 or expected estimate 416); (6) multiplying the estimated number of absences potentially avoided (not shown) by the estimated percentage of absences actually avoided (414 or 416) to provide an estimated number of absences actually avoided 418; (7) dividing the average salary 420 by the number of work days (from inputs 304 of FIG. 3) to provide the average daily salary per employee 422; and (8) multiplying the average daily salary per employee 422 by the estimated number of absences actually avoided 418 to provide the return on investment based on reduction of absenteeism 424.

The average salary 420 used for the ROI calculation may include the cost of benefits.

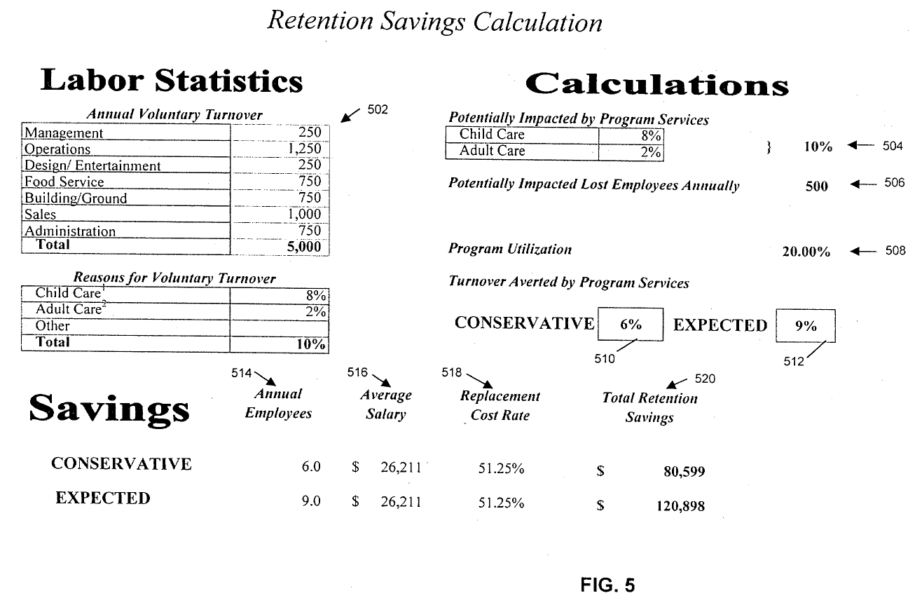

FIG. 5 shows a further example embodiment of the invention for use in calculating the ROI based on cost savings due to employee retention. In this embodiment, the industry statistics may comprise annual voluntary employee turnover 502 for the industry of the employer. The employer specific information may comprise number of employees, average salary per employee, and replacement cost per employee as percentage of average salary (inputs 304 of FIG. 3). The data set may comprise a percentage of the voluntary employee turnover potentially avoided through utilization of the service program 504. The calculation of the return on investment may comprise: (1) multiplying the annual voluntary employee turnover 502 by the percentage of voluntary employee turnover potentially avoided by utilization of the service program 504 to provide a number of potentially impacted lost employees 506; (2) multiplying the number of potentially impacted lost employees 506 by the estimated percentage utilization 508 to provide an estimated number of employee turnovers potentially avoided (not shown); (3) estimating a percentage of employee turnovers actually avoided (e.g., conservative estimate 510 or expected estimate 512); (4) multiplying the estimated number of employee turnovers potentially avoided by the estimated percentage of employee turnovers actually avoided (510 or 512) to provide an estimated number of employee turnovers actually avoided 514; (5) multiplying the estimated number of turnovers actually avoided 514 by the average salary 516 and by the replacement cost percentage 518 to provide the return on investment based on employee retention 520.

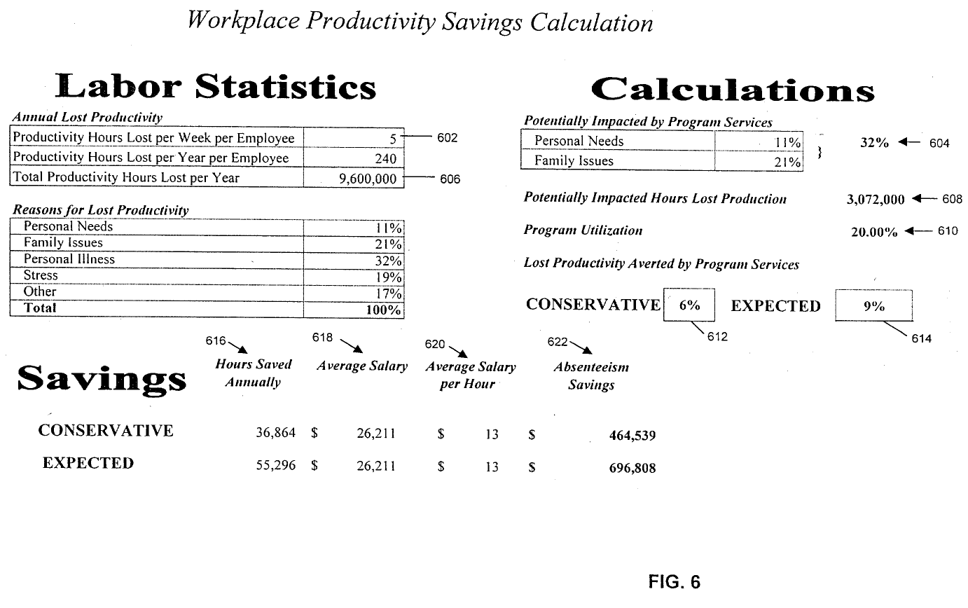

FIG. 6 shows an example embodiment of the invention for use in calculating the ROI based on cost savings due to improved productivity. In such an embodiment, the industry statistics may comprise productivity hours lost per week per employee 602. The employer specific information may comprise number of employees, average salary per employee, number of hours per work day, and number of work weeks per year (e.g., inputs 304 of FIG. 3). The data set may comprise a percentage of the lost productivity hours potentially avoided through utilization of the service program 604. The calculation of the return on investment may comprise: (1) multiplying the productivity hours lost per week per employee 602 by the number of employees and by the number of work weeks to provide the total number of productivity hours lost each year for the employer 606; (2) multiplying the total number of productivity hours lost 606 by the percentage of lost productivity hours potentially avoided by utilization of the service program 604 to provide a number of potentially impacted hours of lost productivity 608; (3) multiplying the number of potentially impacted hours of lost productivity 608 by the estimated percentage utilization 610 to provide an estimated number of lost productivity hours potentially saved (not shown); (4) estimating a percentage of lost productivity hours actually saved (e.g., conservative estimate 612 or expected estimate 614); (5) multiplying the estimated number of lost productivity hours potentially saved by the estimated percentage of lost productivity hours actually saved (612 or 614) to provide an estimated number of lost productivity hours actually saved 616; (6) dividing the average salary 618 by the number of work days and by the number of hours per work day to provide the average hourly salary per employee 620; and (7) multiplying the average hourly salary per employee 620 by the estimated number of lost productivity hours actually saved 616 to provide the return on investment based on improved workplace productivity 622.

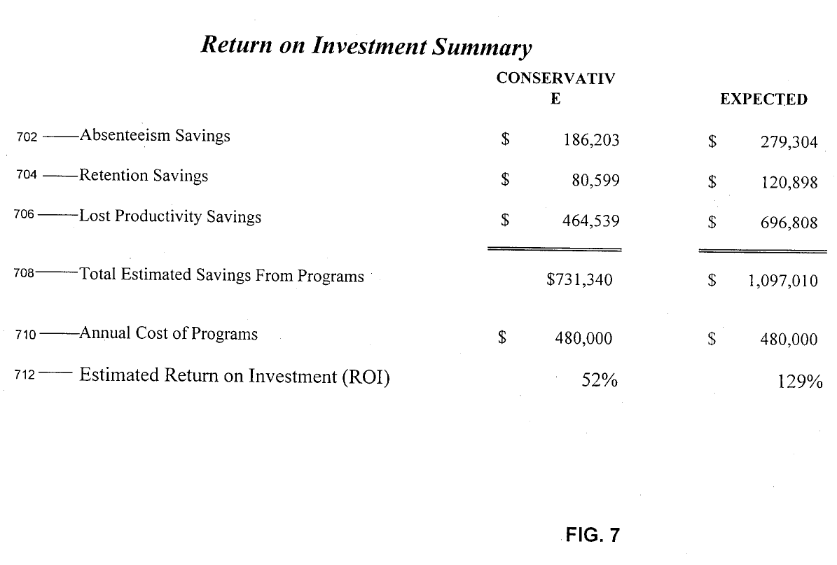

The return on investment may include each of the example embodiments noted above, thereby providing a total return on investment relating to reduced absenteeism, increased productivity, and reduced employee turnover. For example, FIG. 7 summarizes the ROI calculations of FIGS. 4-6. In particular, absenteeism savings 702, retention savings 704, and lost productivity savings 706 are summed to provide total conservative program savings and estimated program savings 708. The annual cost of the program 710 is deducted from the total program savings 708 to arrive at the return dollar amount (not shown). The return dollar amount is divided by the annual cost of the program 710 to provide the ROI percentage 712.

It should now be appreciated that the present invention provides advantageous methods and apparatus for calculating ROI using feedback relating to actual use of the services provided.

Although the invention has been described in connection with various illustrated embodiments, numerous modifications and adaptations may be made thereto without departing from the spirit and scope of the invention as set forth in the claims.

What is claimed is:

1. An interactive method for calculating return on investment for employee services programs, comprising:
inputting industry specific data for an employer;
inputting employer statistics;
providing at least one data set regarding utilization of an employee services program;
estimating a percentage utilization of said employee service program based on said data set; and
calculating said return on investment for said employee service program based on said industry specific data, said employer statistics, and said estimated utilization;
wherein at least one of said industry specific data, said employer statistics, and said estimated utilization can be interactively varied to determine the resultant change on the return on investment calculation.

2. A method in accordance with claim 1, wherein said industry specific data comprises at least one of average employee salaries, daily unscheduled absenteeism rates, replacement costs as a percentage of salary, voluntary employee turnover, or work days per year.

3. A method in accordance with claim 1, wherein said employer statistics comprise at least one of number of employees, cost of benefits, or employee salaries.

4. A method in accordance with claim 1, wherein:
said employer statistics comprise number of employees;
said number of employees is subdivided into different categories of employees; and
the return on investment calculation is performed for at least one category of employees.

5. A method in accordance with claim 1, wherein said at least one data set comprises personalized data obtained from employees who have previously used the employee service program.

6. A method in accordance with claim 5, wherein said at least one data set is obtained by surveying said employees who have previously used said employee service program.

7. A method in accordance with claim 5, wherein said data set comprises at least one of actual number of hours of lost productivity averted through use of said service per employee, actual number of days of absenteeism averted through use of said service per employee, and actual number of employees retained through use of said service.

8. A method in accordance with claim 1, wherein said employee service program comprises at least one of an employee assistance program, a referral service program, an employee information program, a counseling service program, and a benefits service program.

9. A method in accordance with claim 8, wherein said employee service program provides at least one of information, referrals, and counseling.

10. A method in accordance with claim 9, wherein said information, referrals and counseling relate to at least one of child care, elder care, pet care, health care, education, employee benefits, finance, human resources, employee relocation, employment, retirement, and health and wellness.

11. A method in accordance with claim 1, wherein said return on investment calculation comprises at least one of costs saved due to reduced absenteeism, costs saved due to increased productivity, and costs saved due to reduced employee turnover.

12. A method in accordance with claim 1, wherein:
said return on investment comprises cost savings based on reduced absenteeism;
said industry statistics comprise average unscheduled absenteeism rate for the industry of the employer;
said employer specific information comprises number of employees, average salary per employee, and number of work days per year;
said data set comprises a percentage of said unscheduled absences potentially avoided through utilization of said service program; and
said calculation of said return on investment comprises:
multiplying the unscheduled absenteeism rate by the number of employees to provide the number of unscheduled absences per day for said employer;
multiplying the number of unscheduled absences per day by the number of work days per year to provide the number of unscheduled absences per year;
multiplying the number of unscheduled absences per year by the percentage of unscheduled absences potentially avoided by utilization of said service program to provide a number of potentially impacted absences;
multiplying the number of potentially impacted absences by said estimated percentage utilization to provide an estimated number of absences potentially avoided;
estimating a percentage of absences actually avoided;
multiplying the estimated number of absences potentially avoided by the estimated percentage of absences actually avoided to provide an estimated number of absences actually avoided;
dividing the average salary by the number of work days to provide the average daily salary per employee; and
multiplying the average daily salary per employee by the estimated number of absences actually avoided to provide the return on investment based on reduction of absenteeism.

13. A method in accordance with claim 12, wherein said average salary includes cost of benefits.

14. A method in accordance with claim 1, wherein:
said return on investment comprises cost savings based on employee retention;
said industry statistics comprise annual voluntary employee turnover for the industry of the employer;
said employer specific information comprises number of employees, average salary per employee, and replacement cost per employee as percentage of average salary;
said data set comprises a percentage of said voluntary employee turnover potentially avoided through utilization of said service program; and
said calculation of said return on investment comprises:
multiplying the annual voluntary employee turnover by the percentage of voluntary employee turnover potentially avoided by utilization of said service program to provide a number of potentially impacted lost employees;
multiplying the number of potentially impacted lost employees by said estimated percentage utilization to provide an estimated number of employee turnovers potentially avoided;
estimating a percentage of employee turnovers actually avoided;
multiplying the estimated number of employee turnovers potentially avoided by the estimated percentage of employee turnovers actually avoided to provide an estimated number of employee turnovers actually avoided; and
multiplying the estimated number of turnovers actually avoided by the average salary and by the replacement cost percentage to provide the return on investment based on employee retention.

15. A method in accordance with claim 1, wherein:
said return on investment comprises cost savings based on improved workplace productivity;
said industry statistics comprise productivity hours lost per week per employee;
said employer specific information comprises number of employees, average salary per employee, number of hours per work day, and number of work weeks per year;
said data set comprises a percentage of said lost productivity hours potentially avoided through utilization of said service program; and
said calculation of said return on investment comprises:
multiplying the productivity hours lost per week per employee by the number of employees and by the number of work weeks to provide the total number of productivity hours lost each year for said employer;
multiplying the total number of productivity hours lost by the percentage of lost productivity hours potentially avoided by utilization of said service program to provide a number of potentially impacted hours of lost productivity;
multiplying the number of potentially impacted hours of lost productivity by said estimated percentage utilization to provide an estimated number of lost productivity hours potentially saved;
estimating a percentage of lost productivity hours actually saved;
multiplying the estimated number of lost productivity hours potentially saved by said estimated percentage of lost productivity hours actually saved to provide an estimated number of lost productivity hours actually saved;
dividing the average salary by the number of work days and by the number of hours per work day to provide the average hourly salary per employee; and
multiplying the average hourly salary per employee by the estimated number of lost productivity hours actually saved to provide the return on investment based on improved workplace productivity.

16. A method in accordance with claim 1, wherein different data sets are provided for different employee services programs.

17. A method in accordance with claim 1, wherein different data sets are provided for different industries.

18. A method in accordance with claim 1, wherein different data sets are provided for different categories of employees.

19. A method in accordance with claim 1, wherein said data sets are obtained via surveys.

20. A method in accordance with claim 19, wherein said surveys comprise at least one of online surveys, email surveys, in-person surveys, or mail-in surveys.

21. A method in accordance with claim 19, wherein said surveys comprise confidential surveys.

22. An apparatus for calculating return on investment for employee services programs, comprising:
a database for storing at least one data set regarding utilization of an employee services program;
input means for: (i) inputting industry specific data for an employer; (ii) inputting employer statistics; and (iii) estimating a percentage utilization of said employee service program based on said data set; and
a processor for calculating said return on investment for said employee service program based on said industry specific data, said employer statistics, and said estimated utilization;
wherein at least one of said industry specific data, said employer statistics, and said estimated utilization can be interactively varied to determine the resultant change on the return on investment calculation.

23. Apparatus in accordance with claim 22, wherein said industry specific data comprises at least one of average employee salaries, daily unscheduled absenteeism rates, replacement costs as a percentage of salary, voluntary employee turnover, or work days per year.

24. Apparatus in accordance with claim 22, wherein said employer statistics comprise at least one of number of employees, cost of benefits, or employee salaries.

25. Apparatus in accordance with claim 22, wherein:
said employer statistics comprise number of employees;
said number of employees is subdivided into different categories of employees; and
said processor calculates said return on investment for at least one category of employees.

26. Apparatus in accordance with claim 22, wherein said at least one data set comprises personalized data obtained from employees who have previously used the employee service program.

27. Apparatus in accordance with claim 26, wherein said at least one data set is obtained by surveying said employees who have previously used said employee service program.

28. Apparatus in accordance with claim 26, wherein said data set comprises at least one of actual number of hours of lost productivity averted through use of said service per employee, actual number of days of absenteeism averted through use of said service per employee, and actual number of employees retained through use of said service.

29. Apparatus in accordance with claim 22, wherein said employee service program comprises at least one of an employee assistance program, a referral service program, an employee information program, a counseling service program, and a benefits service program.

30. Apparatus in accordance with claim 29, wherein said employee service program provides at least one of information, referrals, and counseling.

31. Apparatus in accordance with claim 30, wherein said information, referrals and counseling relate to at least one of child care, elder care, pet care, health care, education, employee benefits, finance, human resources, employee relocation, employment, retirement, and health and wellness.

32. Apparatus in accordance with claim 22, wherein said return on investment calculation comprises at least one of costs saved due to reduced absenteeism, costs saved due to increased productivity, and costs saved due to reduced employee turnover.

33. Apparatus in accordance with claim 22, wherein:
said return on investment comprises cost savings based on reduced absenteeism;
a percentage of absences actually avoided is estimated based on said estimated utilization and input via the input means;
said industry statistics comprise average unscheduled absenteeism rate for the industry of the employer;
said employer specific information comprises number of employees, average salary per employee, and number of work days per year;
said data set comprises a percentage of said unscheduled absences potentially avoided through utilization of said service program; and
said processor calculates said return on investment by:
multiplying the unscheduled absenteeism rate by the number of employees to provide the number of unscheduled absences per day for said employer;
multiplying the number of unscheduled absences per day by the number of work days per year to provide the number of unscheduled absences per year;
multiplying the number of unscheduled absences per year by the percentage of unscheduled absences potentially avoided by utilization of said service program to provide a number of potentially impacted absences;
multiplying the number of potentially impacted absences by said estimated percentage utilization to provide an estimated number of absences potentially avoided;
multiplying the estimated number of absences potentially avoided by the estimated percentage of absences actually avoided to provide an estimated number of absences actually avoided;
dividing the average salary by the number of work days to provide the average daily salary per employee; and
multiplying the average daily salary per employee by the estimated number of absences actually avoided to provide the return on investment based on reduction of absenteeism.

34. Apparatus in accordance with claim 33, wherein said average salary includes cost of benefits.

35. Apparatus in accordance with claim 22, wherein:
said return on investment comprises cost savings based on employee retention;
a percentage of employee turnovers actually avoided is estimated based on said estimated utilization and input via the input means;
said industry statistics comprise annual voluntary employee turnover for the industry of the employer;
said employer specific information comprises number of employees, average salary per employee, and replacement cost per employee as percentage of average salary;
said data set comprises a percentage of said voluntary employee turnover potentially avoided through utilization of said service program; and
said processor calculates said return on investment by:
multiplying the annual voluntary employee turnover by the percentage of voluntary employee turnover potentially avoided by utilization of said service program to provide a number of potentially impacted lost employees;
multiplying the number of potentially impacted lost employees by said estimated percentage utilization to provide an estimated number of employee turnovers potentially avoided;
multiplying the estimated number of employee turnovers potentially avoided by the estimated percentage of employee turnovers actually avoided to provide an estimated number of employee turnovers actually avoided; and
multiplying the estimated number of turnovers actually avoided by the average salary and by the replacement cost percentage to provide the return on investment based on employee retention.

36. Apparatus in accordance with claim 22, wherein:
said return on investment comprises cost savings based on improved workplace productivity;
a percentage of lost productivity hours actually saved is estimated based on said estimated utilization and input via the input means;
said industry statistics comprise productivity hours lost per week per employee;
said employer specific information comprises number of employees, average salary per employee, number of hours per work day, and number of work weeks per year;
said data set comprises a percentage of said lost productivity hours potentially avoided through utilization of said service program; and
said processor calculates said return on investment by:
multiplying the productivity hours lost per week per employee by the number of employees and by the number of work weeks to provide the total number of productivity hours lost each year for said employer;
multiplying the total number of productivity hours lost by the percentage of lost productivity hours potentially avoided by utilization of said service program to provide a number of potentially impacted hours of lost productivity;
multiplying the number of potentially impacted hours of lost productivity by said estimated percentage utilization to provide an estimated number of lost productivity hours potentially saved;
multiplying the estimated number of lost productivity hours potentially saved by said estimated percentage of lost productivity hours actually saved to provide an estimated number of lost productivity hours actually saved;
dividing the average salary by the number of work days and by the number of hours per work day to provide the average hourly salary per employee; and
multiplying the average hourly salary per employee by the estimated number of lost productivity hours actually saved to provide the return on investment based on improved workplace productivity.

37. Apparatus in accordance with claim 22, wherein different data sets are provided for different employee services programs.

38. Apparatus in accordance with claim 22, wherein different data sets are provided for different industries.

39. Apparatus in accordance with claim 22, wherein different data sets are provided for different categories of employees.

40. Apparatus in accordance with claim 22, wherein said data sets are obtained via surveys.

41. Apparatus in accordance with claim 40, wherein said surveys comprise at least one of online surveys, email surveys, in-person surveys, or mail-in surveys.

42. Apparatus in accordance with claim 40, wherein said surveys comprise confidential surveys.
